(19) United States
(12) Patent Application Publication
(10) Pub. No.: US 2007/0103700 A1
(43) Pub. Date: May 10, 2007

(54) Moving device

(75) Inventor: Wen-Ssu Chiu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/448,571

(22) Filed: Jun. 7, 2006

(30) Foreign Application Priority Data
Nov. 4, 2005 (CN) 200510101031.7

(51) Int. Cl. G01B 11/14

(52) U.S. Cl. 356/622

(57) ABSTRACT

An accurate moving device (100) for use in precision machinery includes a moving member (10), a light emitter (20), a light receiver (30) and a driving element (40). The light emitter is disposed on the moving member in a manner so as to emit light. The light receiver is configured for receiving the light and thereby generating a position signal of the moving member corresponding to the light, the signal is then used for controlling the moving member. The driving element (40) is configured for driving the moving member to move along a first axis and a second axis perpendicular to the first axis.

### TECHNICAL FIELD

The present invention generally relates to accurate moving devices and, more particularly, to an accurate moving device for use in precision machinery.

### BACKGROUND

With the development of accurate manufacturing, accurate moving devices are widely used in precision machinery for mounting work pieces. As the precision required in the manufacturing of working piece becomes higher and higher, so the requirement for moving precision of accurate moving device has also increased. In a typical precision machine, moving precision is generally improved by improving the manufacturing precision and the assembly of components of the precision machine. However, as the manufacturing precision and the assembling precision of components are improved, the precision machine itself may also become more expensive.

In addition, when the precision machine is used for a period of time, the moving precision of the accurate moving device will be decreased by misuse, abrasion of components, and by general wear-and-tear. In most cases this can only be fixed by replacing the damaged parts. Therefore, the accurate moving device used in the typical precision machine cannot achieve a stable level of precision, and in addition is not capable of acting in real time.

What is needed, therefore, is a moving device for use in precision machinery which can be used for real time control, and can achieve stable high moving precision.

### SUMMARY

In one preferred embodiment thereof, a moving device for use in precision machinery includes a moving member, a light emitter, a light receiver, and a driving element. The light emitter is disposed on the moving member in a manner so as to emit light. The light receiver is configured for receiving the light and thereby generating a position signal of the moving member corresponding to the light, the signal is used for controlling the moving member. The driving element is configured for driving the moving member to move along a first axis and a second axis perpendicular to the first axis.

Other advantages and novel features of a preferred embodiment of the present accurate moving device and its applications will become more apparent from the following detailed description when taken in conjunction with the accompanying drawings.

### BRIEF DESCRIPTION OF THE DRAWINGS

Many aspects of the moving device and their applications can be better understood with reference to the following drawings. The components in the drawings are not necessarily drawn to scale, the emphasis instead being placed upon clearly illustrating the principles of the moving device. Moreover, in the drawings, like reference numerals designate corresponding parts throughout the several views.

FIG. 1 is a schematic view of a moving device in accordance with a preferred embodiment of the present invention.

### DETAILED DESCRIPTION OF PREFERRED EMBODIMENTS

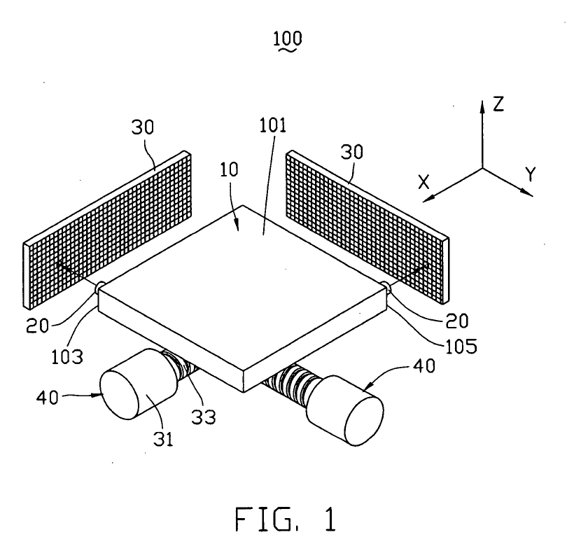

Referring to FIG. 1, in a preferred embodiment, a moving device 100 includes a moving member 10, a light emitter 20 disposed on the moving member 10, and a light receiver 30 and a driving element 40. The accurate moving device 100 is used in a precision machine (not shown) such as a computerized numerical control (CNC) device. The precision machine has a processor for controlling adjusting a position of the moving member 10. The processor stores a series of required moving values when the moving member 10 moves normally.

The moving member 10 is substantially a square stage having a working plate 101 parallel to a X-Y plane, a first sidewall 103, and a second side wall 105 perpendicularly connecting to the first sidewall 103. The first sidewall 103 and the second sidewall 105 are both perpendicular to the working plate 101. An engaging structure (not shown) is disposed below the moving member 10 for engaging with the driving element 40 so that the moving member 10 can be driven to move along an X direction or along a Y direction.

The light emitter 20 includes two light sources disposed with one at either of the first sidewall 103 and the second side wall 105 of the moving member 10. Each of the light sources can emit a collimated light such as a laser beam. In this preferred embodiment, the collimated light is emitted horizontally from the two light sources.

The light receiver 30 has two image sensors disposed adjacent to the first sidewall 103 and the second side wall 105 of the moving member 10. The image sensors are selected from charge coupled devices (CCD) and complementary metal-oxide semiconductors (CMOS). One of the image sensors is parallel to the first sidewall 103, and the other one is parallel to the second sidewall 105. Each of the image sensors is connected to the processor of the precision machine. The image sensors of the light receiver 30 receive the light emitting from the light emitter 20, and send a position signal of the moving member 10 to the processor. The processor changes the position signal into a coordinate value. The processor then calculates a total departure value of the moving member 10 according to the required moving value.

The driving element 40 includes two motors 31, two screw structures 33, and a controller (not shown). One end of each screw structure 32 engages with the engaging structure of the moving member 10 and the other end of each screw structure 33 is connected to one of the motors 31. One of the motors 31 drives the moving member 10 to move along an X direction and the other motor 31 drives the moving member 10 to move along a Y direction. The X direction is perpendicular to the Y direction. The controller is connected with the motors 31 and the processor of the precision machine.

In use, when the moving member 10 needs to move along a required moving route, the light source on the first sidewall 103 emits a collimated light to the image sensor parallel to the first sidewall 103. Then, the image sensor parallel to the first sidewall 103 receives the light and sends a position signal of the moving member 10 to the processor so that the processor can receive a coordinate value along X direction, for example X1. The light source on the second sidewall 105 also emits a collimated light to the image sensor parallel to the second sidewall 105. Then, the image sensor the parallel to the second sidewall 103 receives the light and sends a position signal of the moving member 10 to the processor so that the processor can receive a coordinate value along Y direction, for example Y1. If the X coordinate value of one object position of the required moving route is X0, and the Y coordinate value of such position is Y0, the total departure value of the moving member 10 according to the object position is X0-X1 along the X direction, and Y0-Y1 along the Y direction. Then, the processor 302 sends a moving signal to the controller of the driving element 40 according to the total departure value X0-X1, Y0-Y1 so as to reach the object position. In the same way, the moving member 10 can move to other object positions of the required moving route.

Acting in co-operation with the screw structure 32, the motor 31 drives the moving member 10 to move according to the moving signal so that the moving member 10 moves along a required moving route. Therefore, the moving device 100 can achieve real time control by compensating the for the departure value, thus, the moving member 10 can move along a required moving route and achieves stable high moving precision.

In the alternative embodiment, the moving member 10 can be of a shape other than square and the light emitter 20 can have more than two light sources.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A moving device for use in precision machinery, comprising:
a moving member;
a light emitter disposed on the moving member in a manner so as to emit a light;
a light receiver for receiving the light and thereby generating a position signal of the moving member corresponding to the light, the position signal used for controlling the moving member; and
a driving element for driving the moving member to move along a first axis and a second axis perpendicular to the first axis.

2. The moving device as claimed in claim 1, wherein the moving member is substantially a square stage having a working plate, a first sidewall, and a second side wall perpendicularly connecting to the first sidewall.

3. The moving device as claimed in claim 2, wherein the first sidewall and the second sidewall are both perpendicular to the working plate.

4. The moving device as claimed in claim 2, wherein the moving member has an engaging structure disposed therebelow for engaging with the driving element so that the moving member can be driven to move along the first and second axes.

5. The moving device as claimed in claim 2, wherein the light emitter includes two light sources disposed with one at either of the first sidewall and the second sidewall of the moving member.

6. The moving device as claimed in claim 5, wherein each of the light sources emits a collimated light and the collimated light is emitted horizontally from the two light sources.

7. The moving device as claimed in claim 2, wherein the light receiver has two image sensors disposed adjacent to the first sidewall and the second sidewall of the moving member.

8. The moving device as claimed in claim 7, wherein one of the image sensors is parallel to the first sidewall, and the other one is parallel to the second sidewall.

9. The moving device as claimed in claim 7, wherein each of the image sensors is one of a charge coupled device and a complementary metal-oxide semiconductor.

10. The moving device as claimed in claim 7, wherein the driving element includes two motors, and two screw structures driven by the two motors, one end of each screw structure engages with the engaging structure of the moving member and the other end of each screw structure is connected to one of the motors.

11. The moving device as claimed in claim 10, wherein one of the motors drives the moving member to move along the first axis and the other motor drives moving member to move along the second axis.

12. The moving device as claimed in claim 10, wherein the motors are controlled by a moving signal corresponding to the position signal.

13. An apparatus for detecting position of a moving member which is movable along a first axis and a second axis perpendicular to the first axis, the apparatus comprising:
a first light emitter mounted to the moving member in a manner so as to emit a first light along the first axis;
a second light emitter mounted to the moving member in a manner so as to emit a second light along the second axis;
a first image sensor located so as to receive the first light thereby detecting the position of the moving member along the second axis; and
a second image sensor located so as to receive the second light thereby detecting the position of the moving member along the first axis.

14. The apparatus as claimed in claim 13, wherein each of the light emitter emits a collimated light and the collimated light is emitted horizontally from the two light emitters.

15. The apparatus as claimed in claim 13, wherein a driving element is configured for driving the moving member, and the driving element includes two motors, and two screw structures driven by the two motors.

16. The apparatus as claimed in claim 15, wherein one of the motors drives the moving member to move along the first axis and the other motor drives moving member to move along the second axis.

17. The apparatus as claimed in claim 16, wherein the motors are controlled by a moving signal corresponding to the position signal.

18. A precision machine comprising:
a moving member for carrying a workpiece;
a driving assembly configured for driving the moving member to move along a first axis and a second axis; and
a position detecting assembly configured for detecting a position signal of the moving member in real-time and feedbacking the position signal to the driving assembly to control the driving of the moving member, the position detecting assembly including a plurality of light emitters and a plurality of light receivers,
wherein the plurality of light emitters include first and second light emitters mounted to the moving member in a manner so as to emit first and second lights along the first and second axes, respectively; and
wherein the plurality of light receivers include first and second light receivers located so as to receive the first and second lights thereby generating the position signal of the moving member along the second axis and the first axis, respectively.

19. The precision machine of claim 18, wherein the first and second axes are perpendicular to each other.

20. The precision machine of claim 18, wherein the driving assembly includes first and second motors for driving the moving member along the first and second axes, respectively.
